(19) United States
(12) Patent Application Publication
(10) Pub. No.: US 2003/0228651 A1
(43) Pub. Date: Dec. 11, 2003

(54) Method for separating microorganisms from a food matrix for biodetection

(76) Inventors: Amanda Votaw, Garden City, KS (US); Paul E. Johnson, Laramie, WY (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 10/382,253

(22) Filed: Mar. 5, 2003

Related U.S. Application Data
(60) Provisional application No. 60/361,994, filed on Mar. 5, 2002.

(51) Int. Cl. G01N 1/18

(52) U.S. Cl. 435/29; 436/177

(57) ABSTRACT

A process with several variations that removes bacteria from food by mechanical means while adequately filtering the food matrix sufficiently for analysis in cytometer. In a first variation, the specimen (e.g. ground beef) is combined with water or liquid buffer, stomached, and the liquid collected for measurement in a flow cytometer. In a second variation, the specimen is combined with water or liquid buffer, vortexed and the liquid supernatant is collected for measurement in a flow cytometer. In a third variation, the specimen is combined with water or liquid buffer, placed in a sonicating water bath and the supernatant collected for measurement in a flow cytometer.

### BACKGROUND OF THE INVENTION

This application claims the benefit of U.S. Provisional Application No. 60/361,994, filed Mar. 5, 2002.

### FIELD OF THE INVENTION

“Many rapid methods have been developed that are capable of detecting low numbers of bacteria in pure culture, but these do not always work efficiently when applied to complex food materials, owing to the presence of particulate and soluble components which cause background interference” (Rodrigues-Szulc, U. M. et al., 1996). In order to sensitively detect pathogenic bacteria in food to remove bacteria from the food and concentrate it prior to testing, new testing procedures need to be developed (ibid.).

One of the chief means of separating microorganisms from food uses an initial “stomaching” which homogenizes the food to first order (Sharpe and Jackson, 1972). However, “the method only achieves partial success in removing micro-organisms as it fails to disrupt the many physicochemical forces involved in the adhesion of bacteria to food surfaces. If the target organisms remain attached to very small particles after the initial stomaching stage, the effectiveness of subsequent separation processes will be severely impaired.” (Rodrigues-Szulc, U. M. et al., 1996).

These examples from recent literature “teach against” using mechanical means, such as stomaching, to separate bacteria from food prior to testing.

Some of the recently published techniques for removing bacteria from ground beef include:

1. Using a combination of detergent and enzyme treatment with differential centrifugation prior to detection by plate count and DEFT (Direct Epifluorescent Filter Technique) (Rodrigues-Szulc, U. M. et al, 1996).

2. Using surface adhesion onto polycarbonate filters (Sheridan et al., 1998).

3. Blending and subsequent centrifugation to separate fat, aqueous, and tissue layers, and the subsequent removal of the aqueous layer which presumably contains the great majority of bacteria (Carroll et al., 2000).

These techniques are all flawed and do not produce the required separation of bacteria from food matrix.

### References

Carroll S. A., L. E. Carr, E. T., Mallinson, C. Lamichanne, B. E. Rice, D. M. Rollins, and Joseph, S. W. 2000. “Development and Evaluation of a 24-hour Method for the Detection and Quantification of Listeria monocytogenes in Meat Products.” J. Food Prot., 63, p. 347-353.

Rodrigues-Szulc, U. M., Ventoura, G., Mackey, B. M., and Payne, M. J. 1996. “Rapid Physicochemical Detachment, Separation and Concentration of Bacteria from Beef Surfaces.” J. Applied Bacteriology, 80, p. 673-681.

Sharpe, A. N. and Jackson, A. K. 1972. “Stomaching: a New Concept in Bacteriological Sample Preparation.” Applied Microbiology, 24, p. 175-178.

Sheridan, J. J., Logue, C. M., McDowell, D. A., Blair, I. S., Hegarty, T., and Toivanen, P. 1998. “The Use of a Surface Adhesion Immunofluorescent (SAIF) Method for the Rapid Detection of Yersinia enterocolitica Serotype O:3 in Meat,” J. Applied Microbiology, 85, p. 737-745.

### SUMMARY OF THE INVENTION

The present invention is a process with several variations that can efficiently, quickly, and inexpensively remove bacteria from food by mechanical means while adequately filtering the food matrix sufficiently for analysis in cytometer.

Three variations on the process of the present invention for separating microorganisms from a food matrix for biodetection are as follows:

1. The specimen (e.g. ground beef) is combined with a fluid such as water or liquid buffer to form a sample, the sample is stomached, and the resulting liquid is collected for measurement in a flow cytometer.

2. The specimen is combined with a fluid such as water or liquid buffer to form a sample, the sample is vortexed and the liquid supernatant is collected for measurement in a flow cytometer.

3. The specimen is combined with a fluid such as water or liquid buffer to form a sample, the sample is placed in a container such as a test tube and sonicated in a sonicating water bath, and the supernatant collected for measurement in a flow cytometer.

Each method may include a filtering step prior to measuring the specimen in a cytometer.

### BRIEF DESCRIPTION OF THE DRAWINGS

FIG. 1 shows a flow diagram illustrating a first process of separating microorganisms from a food matrix for biodetection according to the present invention, utilizing stomaching.

FIG. 2 shows a flow diagram illustrating a second process of separating microorganisms from a food matrix for biodetection according to the present invention, utilizing vortexing.

FIG. 3 shows a flow diagram illustrating a third process of separating microorganisms from a food matrix for biodetection according to the present invention, utilizing a sonicating water bath.

### DETAILED DESCRIPTION OF THE PREFERRED EMBODIMENTS

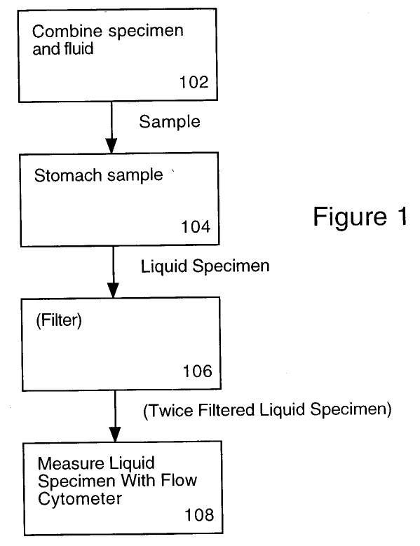

FIGS. 1-3 illustrate three variations on the process of the present invention. Each method efficiently, quickly, and inexpensively removes bacteria from food by mechanical means while adequately filtering the food matrix sufficiently for analysis in a cytometer, preferably a wide-flow-cross-section flow, flow cytometer. Each process performs the separation efficiently, especially with ground beef (which was tested with E. coli K-12):

FIG. 1 illustrates a process using stomaching. In step 102, the specimen (e.g. ground beef) is combined with water or liquid buffer to form a sample. In step 104, the specimen is manually stomached in a bag, which mixes the sample and extracts the liquid including the bacteria, while leaving large food particles behind. A filtering step 106 may be performed after stomaching. In step 108, the liquid specimen is measured in a cytometer.

In a preferred embodiment, VWR-brand Filtra-bag stomacher bags are used during stomaching step 104. These contain a 310-micron inner filter allowing the collection of liquid without the contamination of particles larger than 310 microns . The sample is placed in one side of the stomacher bag, and the slurry is kneaded manually or by a stomacher device. The liquid flows through the filter layer in the stomacher bag to the other side of the bag. This liquid can then be vacuum filtered through a 105-micron polystyrene filter (implementing optional step 106). The filtrate is flowed through a flow-cytometer flow-cell with a large ( around 2 mm) cross-section while maintaining bacterial integrity.

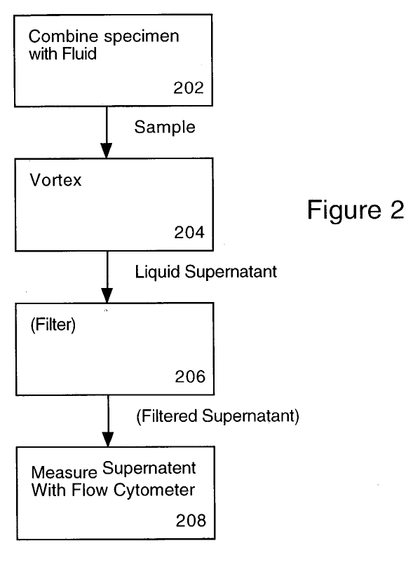

FIG. 2 illustrates a process using vortexing. In step 202, the specimen (e.g. ground beef) is combined with water or liquid buffer to form a sample. In step 204, the sample is vortexed, resulting in a supernatant including bacteria. A filtering step 206 may be performed after vortexing. In step 208, the supernatant is measured in a cytometer. In a preferred embodiment, the ground beef and fluid sample is placed in a 50 ml conical plastic tube (e.g. a tube normally used in centrifuges) with 44.75 ml buffer, vortexed at a 90° angle for 2 minutes at 2000 rpm and the liquid supernatant is collected for measurement in a flow cytometer. The vortexing step 204 vibrates the specimen in a circular pattern, generating a vortex.

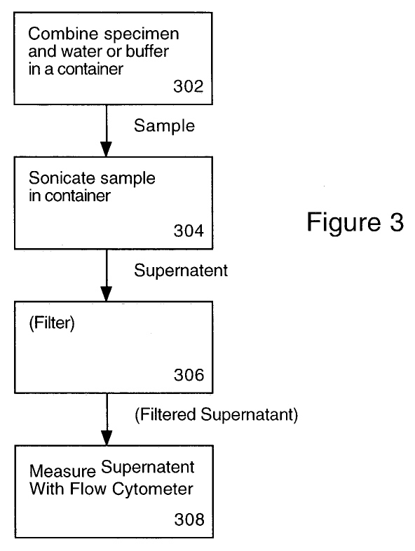

FIG. 3 illustrates a process using a sonicating water bath. In step 302, the specimen (e.g. ground beef) is combined with water or liquid buffer to form a sample. In step 304, the sample is placed in a container such as a test tube and sonicated in a sonicating water bath, resulting in a supernatant including bacteria. A filtering step 306 may be performed next. In step 308, the supernatant is measured in a cytometer. In a preferred embodiment, three grams of ground beef is placed in 26.85 ml buffer for 30 minutes in a sonicating water bath and the supernatant collected for measurement in a flow cytometer.

For all processes, a preferred flow cytometer device (not shown) is a large diameter (around 2 mm cross section) flow, imaged transverse to the flow with a CCD camera.

Results of all three methods show high-efficiencies for manual mixing/stomaching and vortexing with lower efficiencies for sonication. Typical efficiencies were at the 70% level. (In other words, ca. 70% of the E. coli K12 in the beef specimen were recovered as determined by spread plate counting.)

What is claimed is:

1. A method of separating microorganisms from a food matrix specimen for biodetection according to the present invention, comprising the steps of:
combining the food specimen with a fluid to generate a sample;
stomaching the sample to extract a liquid specimen; and
measuring the liquid specimen in a cytometer.

2. The method of claim 1, further including the step of filtering the liquid specimen prior to the measuring step.

3. The method of claim 2, wherein the filtering step comprises vacuum filtering.

4. The method of claim 1, wherein the fluid is water.

5. The method of claim 1, wherein the fluid is buffer.

6. The method of claim 1, wherein the stomaching step is performed in a stomacher bag having approximately a 310-micron inner filter layer.

7. The method of claim 1, wherein the measuring step is performed using a flow cytometer.

8. The method of claim 7, wherein the flow-cell has approximately a 2 mm cross-section.

9. A method of separating microorganisms from a food matrix specimen for biodetection according to the present invention, comprising the steps of:
blending the food specimen with fluid to generate a sample;
vortexing the sample to extract a specimen supernatant; and
measuring the supernatant in a cytometer

10. The method of claim 9, further including the step of filtering the supernatant prior to the measuring step.

11. The method of claim 9, wherein the fluid is water.

12. The method of claim 9, wherein the fluid is buffer.

13. The method of claim 9, wherein the vortexing step includes the steps of:
placing the sample into a conical plastic tube;
vortexing the sample at approximately a 90° angle.

14. The method of claim 13 wherein the vortexing step lasts approximately two minutes at approximately 2000 rpm.

15. The method of claim 9, wherein the measuring step is performed using a flow cytometer.

16. The method of claim 15, wherein the flow-cell has approximately a 2 mm cross-section.

17. A method of separating microorganisms from a food matrix specimen for biodetection according to the present invention, comprising the steps of:
combining the food specimen with fluid to generate a sample;
placing the sample in a container;
sonicating the container and sample to extract a specimen supernatant; and
measuring the supernatant in a cytometer

18. The method of claim 17, further including the step of filtering the supernatant prior to the measuring step.

19. The method of claim 17, wherein the fluid is water.

20. The method of claim 17, wherein the fluid is buffer.

21. The method of claim 17, wherein the combining step comprises placing approximately three grams of ground beef and approximately 26.85 ml buffer in a test tube and the sonicating step comprises sonicating for 30 minutes in a sonicating water bath.

22. The method of claim 17, wherein the measuring step is performed using a flow cytometer.

23. The method of claim 22, wherein the flow-cell has approximately a 2 mm cross-section.
